(19) United States
(12) Patent Application Publication
(10) Pub. No.: US 2014/0258154 A1
(43) Pub. Date: Sep. 11, 2014

(54) System and Method for the Automated Handling of Legal Documents

(71) Applicant: Thomas E. Santarlas, Tampa, FL (US)

(72) Inventor: Thomas E. Santarlas, Tampa, FL (US)

(73) Assignee: Thomas E. Santarlas, Tampa, FL (US)

(21) Appl. No.: 13/864,398

(22) Filed: Apr. 17, 2013

Related U.S. Application Data
(63) Continuation-in-part of application No. 13/789,793, filed on Mar. 8, 2013.

(51) Int. Cl. G06Q 10/10; G06Q 50/18

(52) U.S. Cl. CPC G06Q 10/107; G06Q 50/18
USPC 705/311

(57) ABSTRACT

Disclosed is a system and method for generating, distributing, and accessing private investigation related documents. The system is operated by a host and utilized by a number of different entities that are involved in preparing and distributing private investigated related documents. The system also permits the automated invoicing and billing of private investigation related activities. The archiving of data related to private investigations can also be carried out by the present system. In still yet other embodiments, the system can permit real time editing of reports, the generation of reports via voice recognition, as well as access to streaming broadcasts. Other embodiments permit photographs and/or maps to be embedded into private investigation related reports.

### CROSS REFERENCE TO RELATED APPLICATION

This application claims priority to and is a continuation-in-part of U.S. patent application Ser. No. 13/789,793 filed Mar. 8, 2013 and entitled “System and Method for the Automated Handling of Documents Related to Private Investigations,” which claims priority to and is a continuation-in-part of U.S. patent application Ser. No. 13/029,752 filed on Feb. 17, 2011 and entitled “System and Method for the Automated Distribution, Management and Service of Court-Related Documents,” which claims priority to and is a continuation-in-part of U.S. patent application Ser. No. 13/016,013 filed on Jan. 28, 2011 and entitled “System and Method for the Automated Distribution, Management and Service of Court-Related Documents”, which claims priority to and is a continuation-in-part of U.S. patent application Ser. No. 12/906,099 filed on Oct. 17, 2010 and entitled “System and Method for the Automated Distribution, Management and Service of Court-Related Documents,” now U.S. Pat. No. 8,396,765 issued Mar. 12, 2013, which claims priority to and is a continuation-in-part of U.S. patent application Ser. No. 12/905,702 filed on Oct. 15, 2010 and entitled “System and Method for the Automated Distribution, Management and Service of Court-Related Documents.” The contents of these applications are fully incorporated herein for all purposes.

### BACKGROUND OF THE INVENTION

1. Field of the Invention

This invention relates to an automated handlings of documents. More particularly, the present invention relates to a system for electronically distributing, managing and serving documents related to private investigations.

2. Description of the Background Art

Serving documents such as summonses, complaints, subpoenas, petitions, and warrants upon third parties can be both time consuming and complicated for legal professionals. Effecting service of process has traditionally involved first generating the necessary documents to be served. This requires a detailed knowledge of the rules and regulations in the jurisdiction where the documents are to be served. Often times the legal professional must conduct research to discover these rules and regulations.

Depending upon the nature of the service, the legal professional may also have to get the court in the applicable jurisdiction to certify the documents or issue a summons. This, in turn, requires the legal professional to correspond with the clerk of court, often times via local counsel. Once the documents have been certified, the legal professional must find an individual to hand deliver the documents upon the third party. Finding a reliable process server may be a hit or miss proposition, insomuch as the legal professional may have little familiarity with the jurisdiction in which service is to be effected.

Despite recent advances in computer technology and electronic communications, many of the steps outlined above have remained unchanged. Thus, there exists a need in the legal field for a means of easily and efficiently carrying out service of process. There also exists a need in the field for a system whereby court-related documents can be electronically distributed, managed and, ultimately, served. There is likewise a need for a system for efficiently invoicing for tasks carried out by a process server. Finally, there exists a need for archiving all data associated with effecting service. The system and method of the present invention is aimed at meeting these and other needs.

### SUMMARY OF THE INVENTION

It is therefore one of the objectives of this invention to provide a system for the automated service of court-related documents.

It is also an object of this invention to provide a system for electronically distributing and managing court-related documents prior to being served.

Still another object of this invention is to automate the invoicing associated with tasks carried out by a process server.

A further object of this invention is to enable all data associated with effecting service to be archived for later retrieval.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a flow chart illustrating the system of the present invention.

FIG. 2 is a flow chart illustrating the automated invoicing feature of the present invention.

FIG. 3 is flow chart illustrating the archiving feature of the present invention.

FIG. 4 is a screen shot of a program carrying out the system of the present invention.

FIG. 5 is a screen shot of a program carrying out the archiving feature of the present invention.

FIG. 6 is a flow chart illustrating the automatic e-mail notification system of the present invention.

FIG. 7 is a flow chart illustrating the private investigation system of the present system.

FIGS. 8-12 are screen shots showing various aspects of the private investigation system.

Similar reference characters refer to similar parts throughout the several views of the drawings.

### DETAILED DESCRIPTION OF THE PREFERRED EMBODIMENT

The present invention relates to a system and method for managing, distributing, and serving court-related documents. The system is operated by a host and utilized by a number of different entities that are involved in effecting service of court-related documents such as subpoenas, summonses, complaints, petitions, and warrants. By way of the system, these court-related documents can be electronically distributed and ultimately served in an efficient manner. The system also permits the automated invoicing and billing for service related activities. The archiving of data and/or files related to effecting service can also be carried out by the present system. The details of the present invention are more fully explained hereinafter.

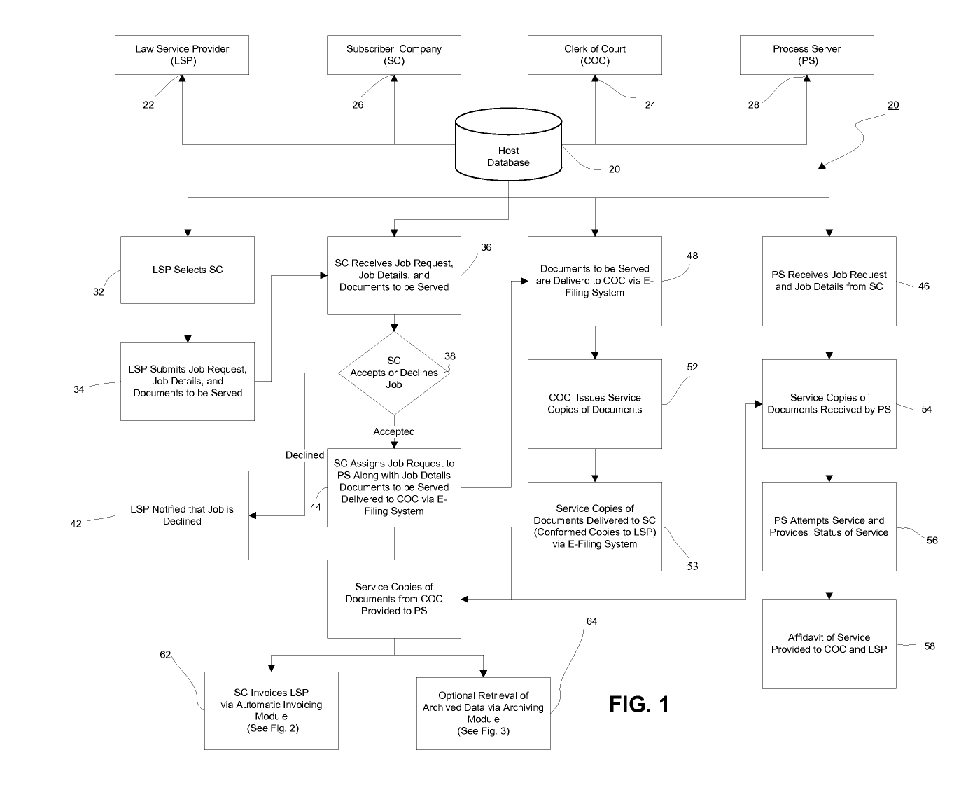

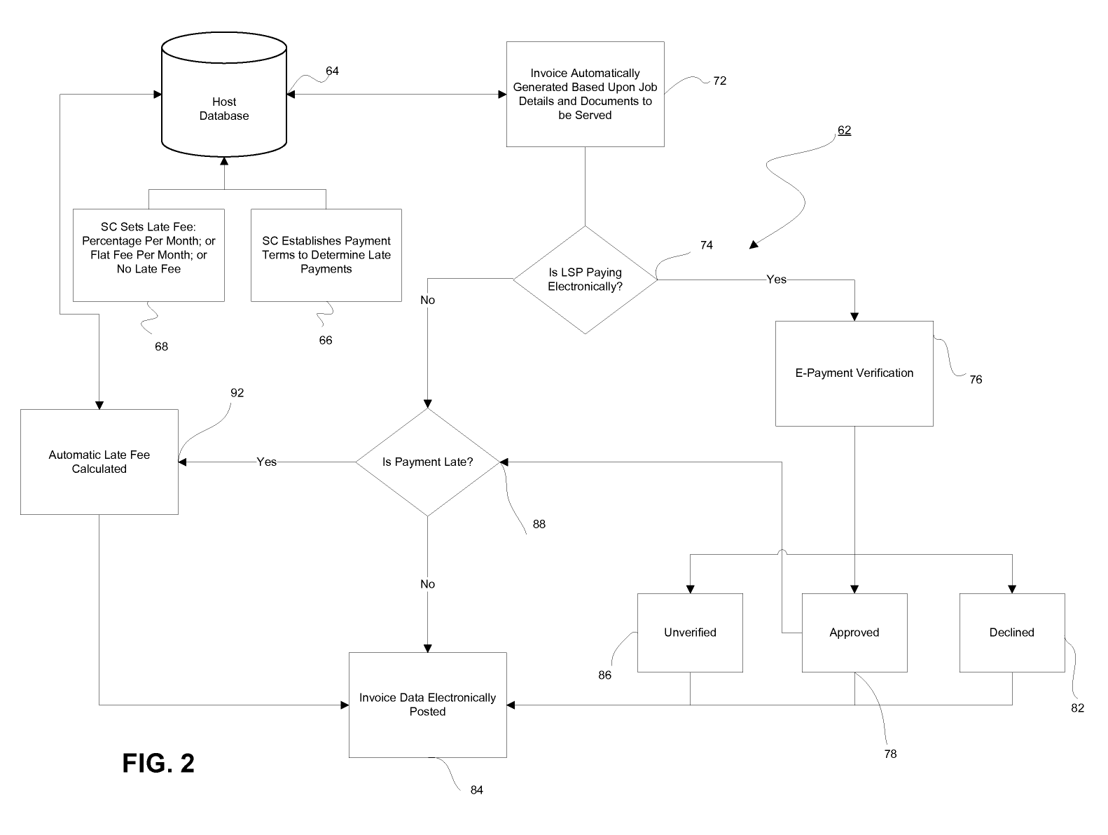

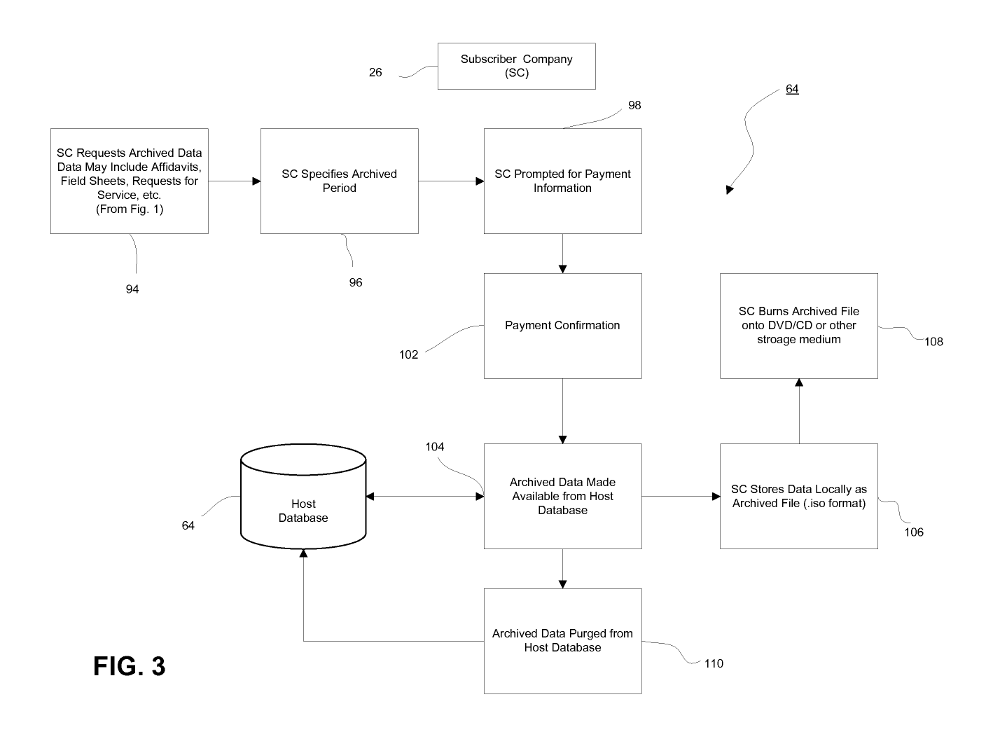

FIG. 1 is a flow chart illustrating the system 20 of the present invention as well as the various entities utilizing the system. These entities include law service providers (LSP) 22, which may include, for example, attorneys, law firms, paralegals, legal secretaries, and/or any other individuals or entities that generate, or assist in creating court-related documents. LSPs may further include, by way of example, law enforcement officers, correctional officers, probation officers, state attorneys, public defenders, private investigators, clerks, other criminal justice practitioners, and any other person or entity that creates, serves/delivers or receives legal instruments. Legal instruments may include documents such as complaints or subpoenas and may further include other court-related documents, as well as attachments such as maps or photographs.

For purposes of this application, LSP's include, but are not limited to, any client of the subscriber companies described below. Although these clients will often be attorneys or law firms, the LSP definition specifically includes non-law firm corporations, non-attorney individuals, other corporate entities, or individuals representing themselves in a pro-se capacity. Other entities utilizing the system include clerks of court (COC) 24, which broadly includes any government-authorized individuals or entities that are involved in certifying court-related documents or in issuing summonses, or other related documents. For instance, COCs may be involved in providing a summons associated with a complaint or in certifying subpoenas or warrants.

The system may also be used by subscriber companies and process servers. Subscriber companies (SC) 26 are service providers that are involved in the service of court-related documents. This may be, for example, a company that oversees and manages a number of different process servers, either as employees or independent contractors. Finally, the process server (PS) 28 is the individual, or individuals, who are involved in actually effecting service of process. A PS may work as an employee or independent contractor for a particular SC. Alternatively, in some instances, the SC and the PS may be one and the same. Namely, SCs are defined herein as including a PS operating individually.

With continuing reference to FIG. 1, it is seen that the entire system is carried out over a computer network, such as the Internet. Alternatively, the network may comprise a Local Area Network, a Wireless Local Area Network, a Wide Area Network, or a Metropolitan Area Network. The system is also carried out over existing Internet-based, court-sponsored e-filing systems. An example of such a system is the CM/ECF e-filing system currently in place by the U.S. Federal Court System.

In accordance with the step 32 of the system, the LSP selects a particular SC. The LSP then submits a job request, job details, and documents to be served at step 34. At step 36, the SC receives the job request, job details, and court-related documents from the LSP over the network. The job request lists the general details of what the LSP is attempting to accomplish. The job request can be, for example, a request to serve a summons and complaint, or serve a subpoena or warrant. The job details provide further specifics regarding the individual or entity to be served, any applicable deadlines for service, as well as the geographic location for effecting service. Finally, the SC would receive copies of the court-related documents to be served from the LSP via the network. Again, these court-related documents may be a summons, complaint, subpoena, or a warrant. However, those knowledgeable in the legal industry will realize that there are additional court-related documents that have not been specified that could be employed in conjunction with the present invention.

In the next step 38, the SC, after reviewing the job details and the court-related documents, can either elect to accept or decline the job. The job may be declined, for instance, if the SC cannot meet the applicable deadline or if the job details specify a geographic area in which the SC does not operate. The LSP is then notified via the network whether the SC has declined or accepted the job request. In the event that the job is declined, as at step 42, the LSP can select another SC and begin the process anew.

Alternatively, if the SC accepts the job, the SC thereafter assigns the accepted job to a particular PS at step 44. It is envisioned that, in accordance with this system, the SC would maintain a database of numerous PS′ in various geographic areas. Thus, the SC would select the most suitable PS and assign him or her the job request. Additionally, as explained below, the SC would also submit the court-related documents to the COC via the court sponsored e-filing system at step 48. The LSP may alternatively provide the court-related document to the COC, if such a submission is required by the court. Once issued, the service copies of the court-related documents would be provided to the SC with a conformed copy to the LSP. The SC then provides the PS with the job request, job details and service copies of the court-related documents at step 46.

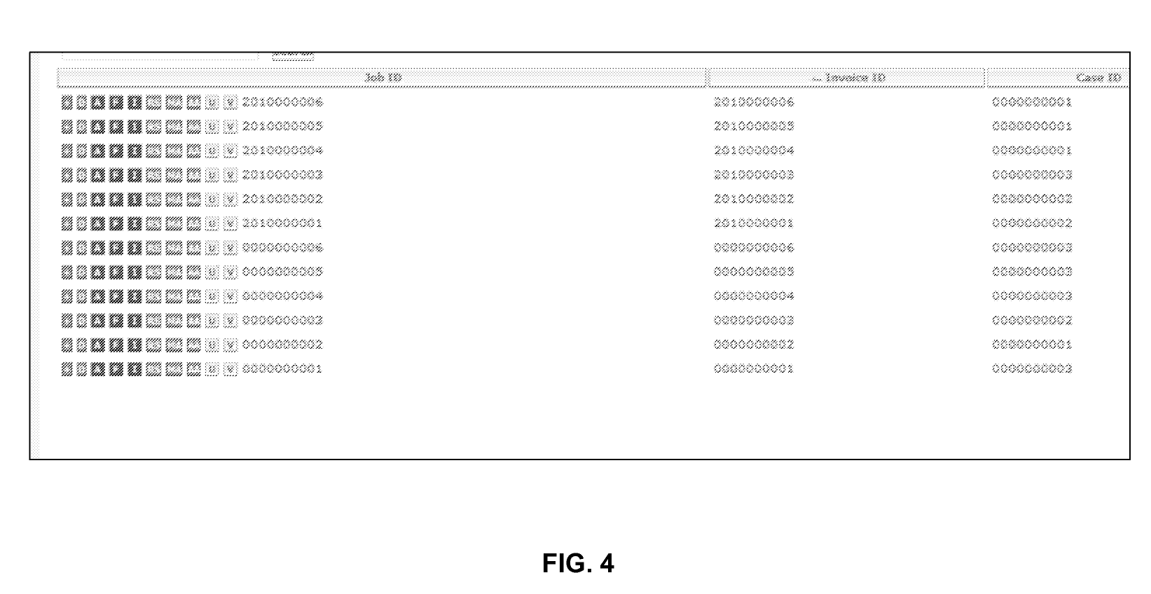

The database maintained by the SC would likewise contain a listing of all accepted jobs, the PS to which the job has been assigned, as well as all job-related details and court-related documents. FIG. 4 is a screen shot illustrating the possible graphical organization of such information within the database. As illustrated, a particular job would be referenced by Job ID, Invoice ID, and Case ID. Hyperlinks would likewise be provided to permit the SC to access any documents associated with a job. These documents may include, for example, invoices to the LSP, requests for service, affidavits of service, field sheets from the PS detailing service attempts, the payment history of the LSP, and/or uploaded attachments. This interface allows the SC to organize and keep track of a number of different jobs over time.

Turning back to FIG. 1, prior to attempting service of the court-related documents, the SC would deliver the documents to the COC at step 48. It is envisioned that this would most likely be carried out by way of the court-sponsored e-filing system. Namely, the documents to be served would be provided to the COC via the e-filing system. The COC would thereafter issue service copies of the documents in a conventional fashion at step 52. The COC would then provide service copies of the court-related documents to the SC. Conformed copies would also be provided to the LSP (note step 53). The SC, in turn, provides the service copies of the court-related documents to the PS for service of process. In an alternative embodiment, the individual PS could directly retrieve the service copies of the documents via the e-filing system at step 54.

With the service copies of the documents in hand, the PS would then attempt service upon the third party in accordance with traditional methods at step 56. The PS can provide electronic status updates regarding the attempts to serve the documents. This could be accomplished by the PS logging into the SC program/database via personalized login credentials and manually inputting the service and/or attempt history data. In addition the status updates could also be provided to the SC for input. Regardless, the data once entered will be available to the LSP via the network.

Finally, once service is effected, the PS would generate an affidavit of service at step 58. This affidavit can be electronically signed by the PS. Such an affidavit could be delivered directly to the LSP via the network. The signed affidavit can also be electronically sent to the COO for filing. It is also envisioned that the SC would obtain a copy of the affidavit of service for storage in the host database.

FIG. 1 also illustrates two additional modules that can be used with the system. These include an invoicing module 62 and an archiving module 64. These modules are described next in conjunction with FIGS. 2 and 4.

### Invoicing Module

The invoicing module 62 automatically invoices an LSP and processes any invoice payments. With reference to FIG. 2, it is shown that the module utilizes a database 64, which contains payment terms that are previously established by the SC at steps 66 and 68. These payment terms may include the amounts to be charged for various jobs. These amounts would be based, in part, on the job details and the court-related documents to be served. The payment terms stored in the database further include when the invoice is payable and the applicable late fee. The module thereafter automatically generates an invoice to an LSP at step 72 on the basis of an accepted job. Again, the invoice is automatically generated in accordance with the established payment terms stored in database 64.

Thereafter, the module automatically determines whether the LSP is providing an electronic payment over the network at step 74. If such an electronic payment is being made, the SC verifies the payment at step 76. Namely, the SC either approves the payment at step 78 or declines the payment at step 82. The approval or lack of approval is reflected by an electronically updated invoice at step 84. Likewise, if the e-payment has neither been approved nor declined but is rather unverified, such as at step 86, this information, too, is electronically posted to the invoice at step 84.

Thereafter, whether the LSP is paying electronically or otherwise, the module automatically determines whether the invoice payment is late at step 88. This determination is made with reference to the established payment terms stored in the database. If the determination is made that the payment is late, an automatic late fee is computed by the module at step 92, with the late fee being computed in accordance with the established payment terms. Finally, the LSP is provided an updated invoice at step 84 which can be either electronically delivered to the LSP or posted to the database to be accessed by the LSP at a later time. This electronic invoice is updated to reflect approved or declined electronic payments, the delinquent status, and the applicable late fees.

### Archiving Module

With reference to FIG. 3, the archiving module 64 permits the SC to access and store archived data relating to prior job requests. The historical data to be archived may include, but is not limited to, job details, court-related documents, field sheets, affidavits of service, requests for service, uploaded attachments, and invoicing and payment information. The uploaded attachments can include any type of file, such as pictures, videos, websites, sound files, or uploaded attachments. This archived data is initially stored in a host database.

The archiving module accepts a request for archived data from the SC at step 94. Thereafter, the SC is prompted to specify an archived period at step 96. This archived period may be, for example, a week, a month, quarterly, semi-annually, annually or multiple years. The SC is prompted for payment at step 98 before gaining access to the archived data. The amount of payment required depends, in part, upon the length of the archive period specified. This payment is larger for larger archived periods and is smaller for smaller archived periods. Likewise, the payment may also depend, in part, upon the total volume of archived data requested.

In the next step 102, the SC provides an electronic payment. This payment is made directly to the system host. Once payment is confirmed, at step 104, the SC is permitted to access to download the archived data. Thereafter, the SC is permitted to store the downloaded data locally at step 106. This can be done by either storing the archived data on a hard drive, a flash drive, a CD, or a DVD, or on any other type of storage medium (note step 108). It is envisioned that the archived data would be stored in an archived .ISO file format and then burned and saved by the SC to a CD or a DVD, or on any other type of storage medium such as a hard drive and/or a flash drive. Finally, once the data is downloaded from the host database, it can be erased by the host to conserve storage capacity at step 110.

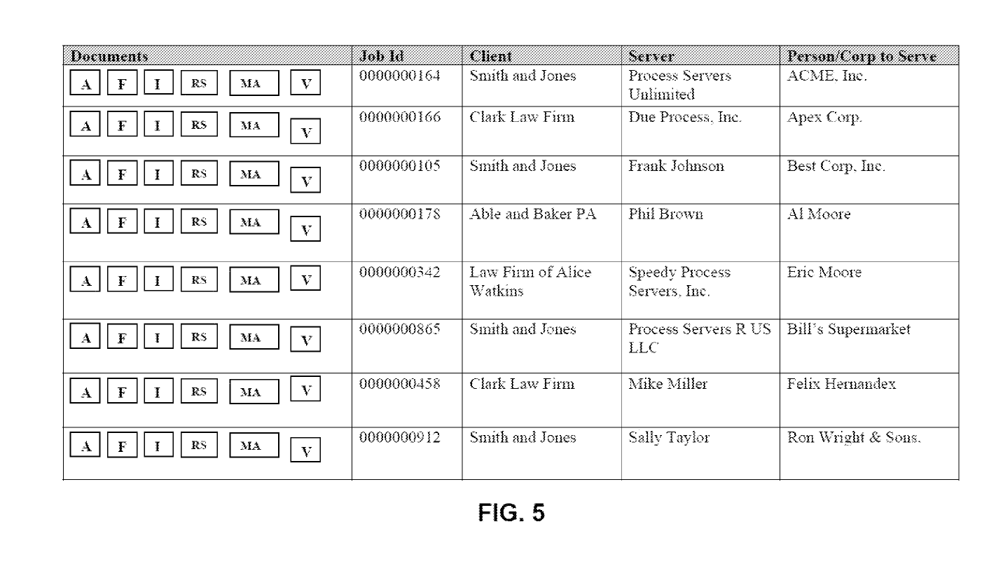

FIG. 5 is a screen shot from a program running the archiving module. This allows the SC to easily see and access all archived data. The screen includes columns for “Job ID”, “Client”, “Server”, and “Person/Corporation to be Served.” Also included are hypertext links to all archived documents. These documents may include, but are not limited to, Affidavits of Service “A,” Field Sheets “F,” Invoices “I,” Requests for Service “RS,” and Mailing Affidavits “MA.” Other attachments, which can be in any of a variety of formats, can be downloaded and stored via the archiving module as well. By clicking on the view “V,” link the user is presented with a listing of all uploaded attachments. Thereafter, by clicking on an individual item in the list, the uploaded attachment can be viewed. The information on the screen can also be sorted by clicking on an individual column heading. For example, clicking on the “Job ID” column, the jobs are arranged in numerical order of the Job ID. Searching can also be carried out via a quick search feature. This allows searching of documents, Job IDs, Clients, Servers or Persons/Corps. to be served. Moreover, as letters are typed into the quick search field, irrelevant data will be removed from the screen.

### E-Mail Notification Module

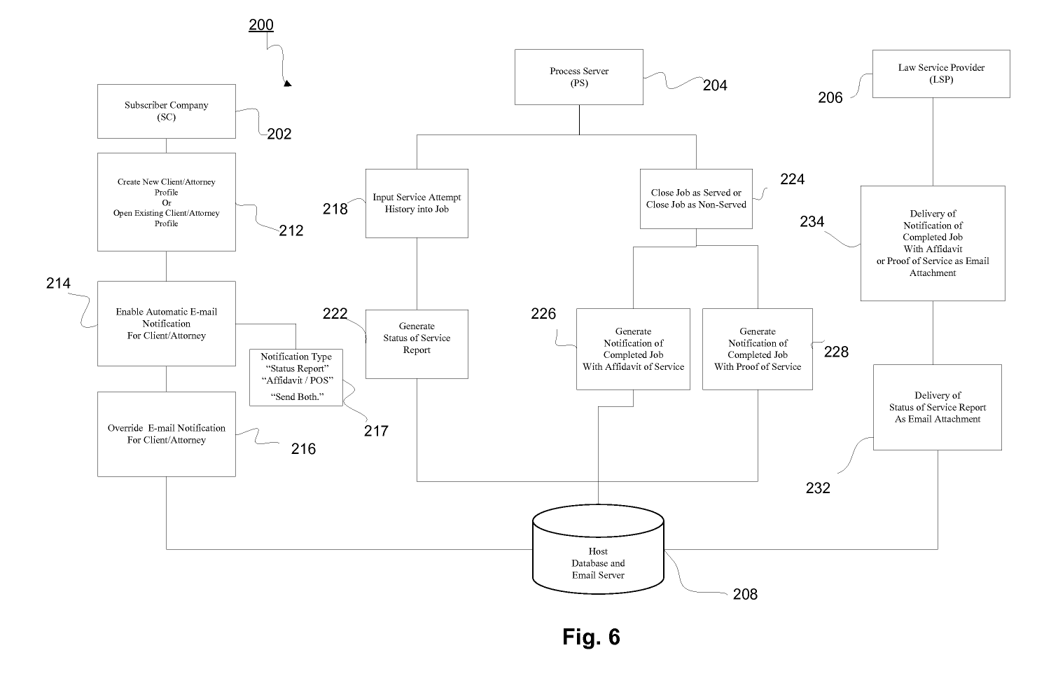

The automatic email notification system 200 is disclosed in connection with FIG. 6. The system 200 includes a subscriber company (SC) 202, a process server (PS) 204, and a law service provider (LSP) 206, all of which are interconnected via an email server 208. The SC 202, PS 204, and LSP 206 are as described above in connection with the primary embodiment. The SC 202, PS 204, and LSP 206 all interact with a host database, which in this embodiment includes the email server 208.

The system 200 permits the SC 202 to send automatic email notifications. Specifically, at step 212 the SC 202 creates a new client/attorney profile or calls up an existing client/attorney profile. As part of each profile, at step 214, the SC 202 can enable the client/attorney to receive an automatic email notification. This can be achieved via a check-mark box or radio button. The automatic emails will thereafter be delivered to the email address on file for the particular LSP 206.

Each job includes an associated job profile menu. This menu includes all relevant information for a particular job or service. This includes, but is not limited to, PS name, client name, attorney name, paralegal name, case caption, priority of service, PS instructions, name of person or corporation to serve, address, etc. A paralegal drop-down menu is accessible from this job profile menu. The SC can also tailor the specific E-mail notifications to be delivered to a LSP. In the profile menu, the SC will be presented with an Automatic E-mail Notification box 217. Clicking on this box will present the SC with the following choices: “Status Report”, “Affidavit/POS”, or “Send Both.” This functionality allows the SC to decide the type of automatic e-mail notification report that will subsequently be transmitted to the LSP client. Depending upon the option selected, the following E-mail notifications are available:
Activating the “Status Report” button will enable status reports to be automatically e-mailed to the LSP.
Activating the “Affidavit/POS” button will enable Affidavit's or POS's to be automatically e-mailed to the LSP.
Activating the “Send Both” button will enable Status Reports and Affidavit's/POS's to be automatically e-mailed to the LSP.

The paralegal drop-down menu includes an override email check-mark box (or radio button). At step 216, this override can be activated so that any automatic email notification, as well as any manually sent emails, will be diverted to the paralegal assigned to a particular job. Namely, any emails sent by the system will be delivered to the email address (or addresses) listed inside the associated paralegal profile. If the box is unchecked, this functionality is deactivated and all emails will go to the email address located in the contact section of the attorney/client profile. This override feature is available on a job-by-by basis and is not a master override.

In accordance with the system, a PS 204 can input service attempts into a particular job ticket at step 218. This will include, for examples, details regarding efforts to effect service on an individual or corporation. Thereafter, a status of service report is automatically generated at step 222. This report is preferably generated as an attachment to an email that is automatically sent via email server 208 to an LSP 206. The email can be automatically sent immediately after the report is generated. The PS 204 can also indicate, at step 224, that a job has been closed due to service being complete or the individual/corporation not being served. Depending upon the particular jurisdiction and court, completion of service can be evidenced by either an affidavit of service or proof of service. At step 226, an affidavit of service is automatically generated as an email attachment. At step 228, a proof of service is automatically generated as an email attachment. In either instance, the email is then automatically sent to the particular LSP 206 associated with the account via email server 208.

In each of the above examples, the report is sent as an email attachment. It is also preferred that the job number associated with the particular project appear in the subject line of the email. The from address can be a “no-reply” format to indicate that it should not be replied to. Other email formatting can also readily be used. For instance, textual emails and/or HTLM formatting can be used in lieu of an email attachment.

Any notifications generated by the PS 204 will be sent to the appropriate LSP 206 via email server 208. The emails will be delivered pursuant to the profile established by the SC 202. This profile can be stored in host database 208. At step 232, the LSP 206 receives the status of service report as an email attachment. The proof of service (e.g. evidencing documents served or not served) or affidavit of service (e.g. evidencing documents served or not served) are received as email attachments at step 234.

The above described system has been described in connection with service of court related documents. However, the system can also be utilized for the automated processing and delivery of documents related to private investigations (i.e. a “PI System”). In the above described example, the Subscriber Companies (SC) would instead be companies involved in providing private investigatory services to clients or “PI Providers.” The Process Servers (PS) referenced above would be replaced by “Private Investigators.” Likewise, the Law Service Providers (LSP) described above, would simply be any individual or company requiring the services of a private investigator, i.e. a “Private Investigator Client”. Finally, instead of utilizing the services of a Clerk of Court (COC), the private investigator may utilize any number of government sponsored websites or databases accessed to retrieve background information on an intended subject, i.e. “Governmental Organizations.” Thus, other than a difference in subject matter, the private investigation system would operate in a manner similar to the above described system. The invoicing, archiving, and e-mail notification systems could likewise be incorporated into the private investigation system. The foregoing system can also be carried out manually without the requirement of a computer network.

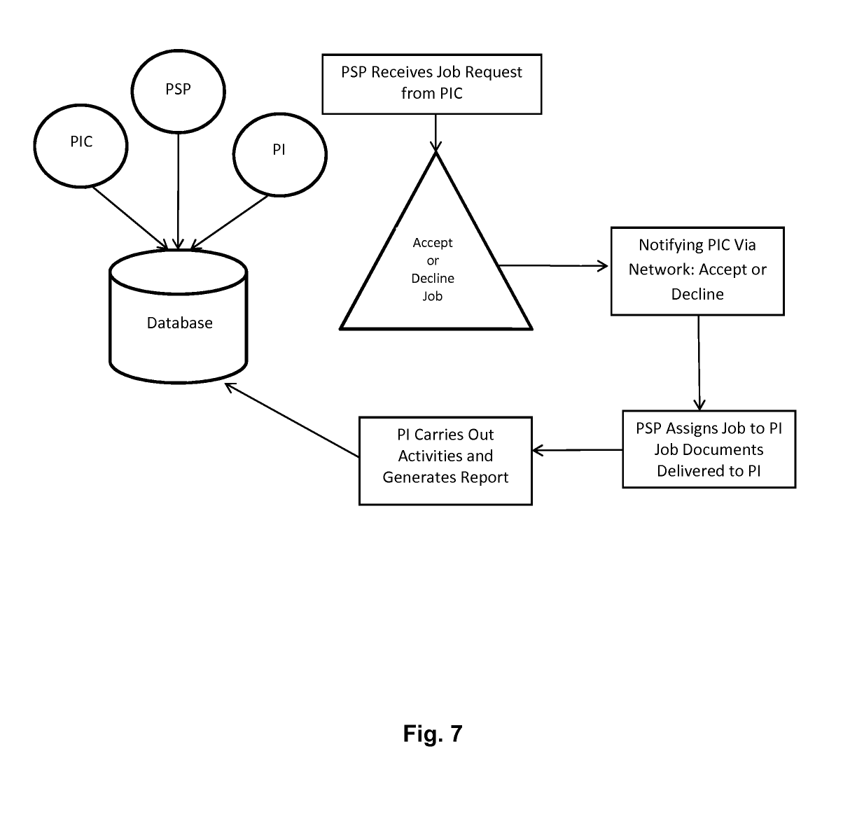

FIG. 7 is a flow chart illustrating one implementation of the PI System. At step one, the Private Investigator Service Provider (PSP) receives a job request from a Private Investigator Client (PIC). The PSP can thereafter either accept or decline the job. If accepted, the PSP assigns the job to a private investigator (PI). The PI can then download the investigation related documents from a central database. The PI then carries out various investigatory activities and generates a report. The report can be uploaded to the database for later retrieval by the PIC, PSP, or PI.

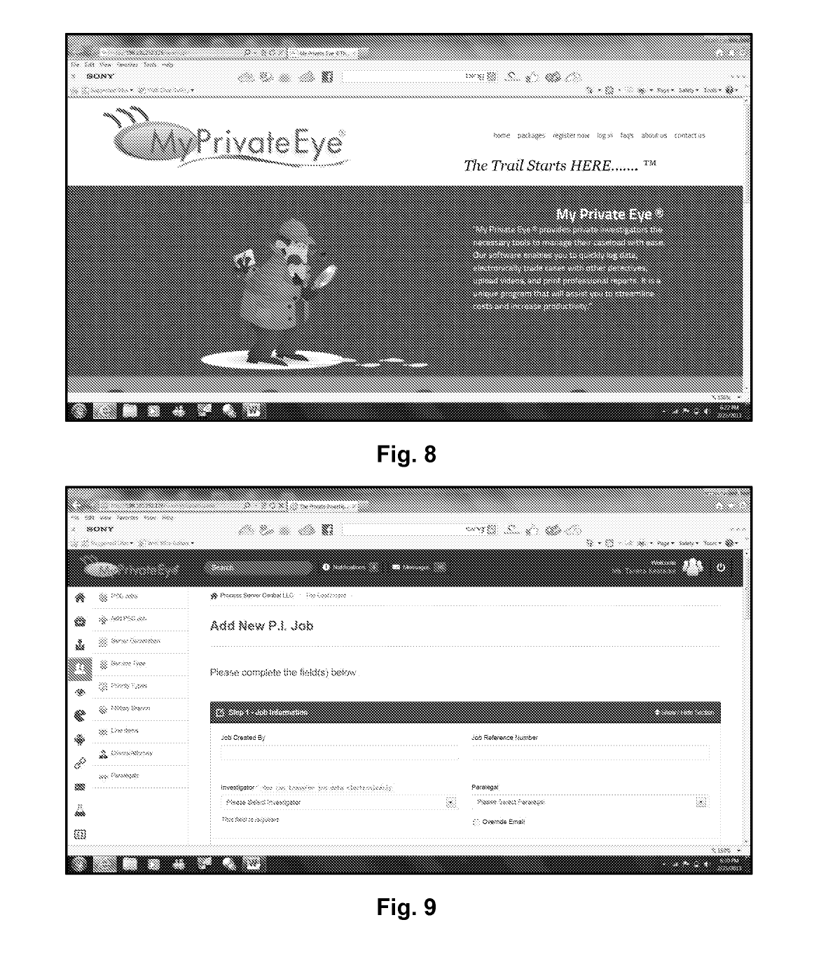

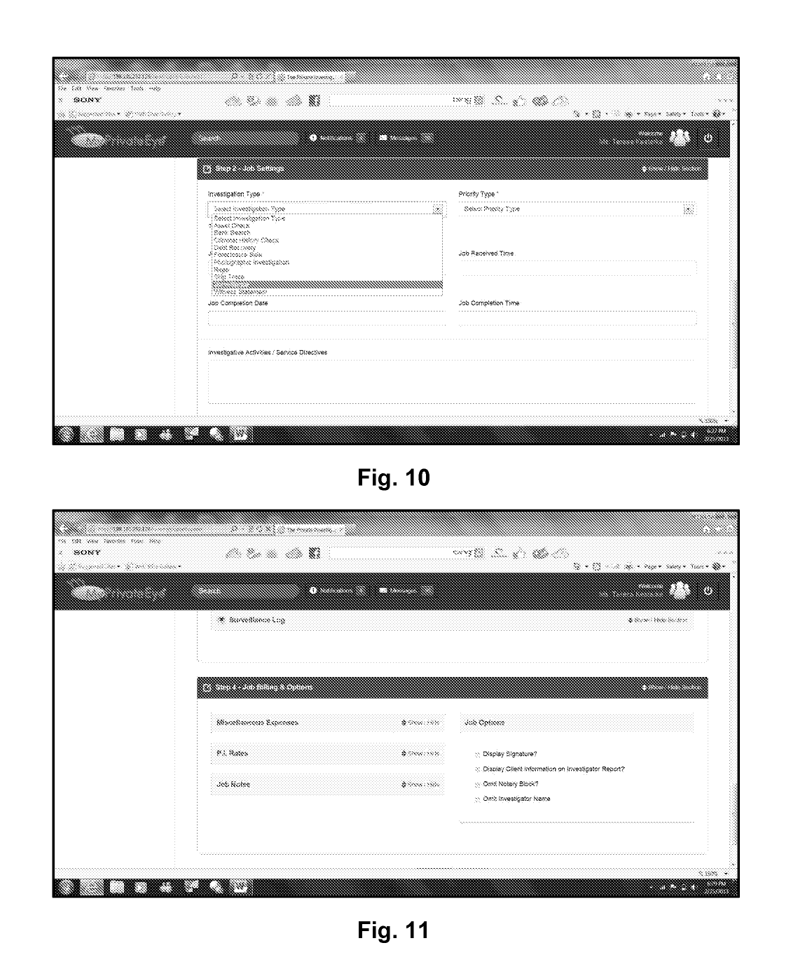

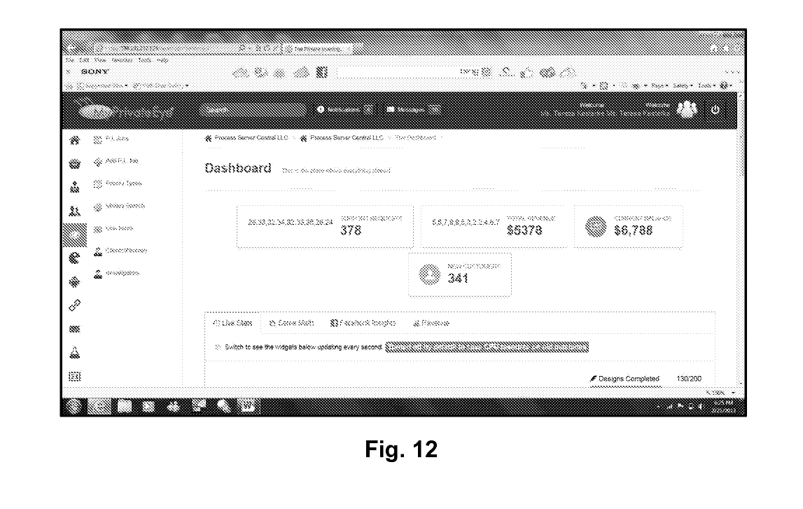

Representative screen shots of the PI System are included as FIGS. 8-12. FIG. 8 is a screen shot of the introductory screen of the PI System. A new job can be added at the screen depicted in FIG. 9. Various job information can be added via this screen. A pull down menu (FIG. 10) can be accessed to enter the type of investigation for the new job. Billing information can be entered via the screen depicted in FIG. 11. FIG. 12 is a view of a dashboard showing total revenues, support requests, and total customers for a particular private investigator.

The PI System could also use one or more of the following modules.

### Real Time Editing Module

The system described above has the capacity to generate documents in a variety of formats, such as Adobe System's portable document format (or “PDF”). These pdf documents are automatically generated from the data entered into the database by the user. Functionality can also be built into the system for allowing two or more users to be reviewing and editing non-PDF documents (text form of an HTML document) at the same time. Each of the users would have an identifying feature attached to their cursor. This may be a cursor of a particular color or the user's initials. All the users that are logged into the program (specific credentials) can observe the document, make changes and observe those changes being made.

This system would allow all editing to be done in real time with everyone on-line seeing and making the changes to the document. Once the edits are completed, the user(s) click a save button and the system automatically makes the changes to the existing PDF document that was originally generated. Here is how the system would work from a user perspective:
There would be another colored box next to each job number. It would be entitled, “LE” for “Live Editing.”
Once this button is activated, the system would ask the user “which report or document would you like to access for live editing?”
The PDF document of the selected report that was initially generated by the system as a PDF would appear as a HTML text document for revision purposes.
The users then can begin to make revisions in real-time that each can visualize from their own computers at the same time.
The users can only edit the documents that are created from our database.

### Streaming Video/Live Broadcast Module

A further aspect of the invention would permit the user to stream video or live broadcasts of private investigation and/or process server activities. Currently when a process server or private investigator takes a picture or conducts a video surveillance, the photo or video can be uploaded into a database and attached to a corresponding job. The attorney, private investigator, paralegal, process server, or other client with login-in credentials then logs into the database to view all the attachments. This can be accomplished via the above described system. The user, however, is limited to simply watching the saved video clip or photo. Various companies provide streaming video services. Once such company is Lifestream. Other companies likewise exist that can provide suitable streaming services. By using an “API” or “Application Programming Interface” provided by such a company, the user of the described system could access streaming video related to a specific case.

### Reports Via Voice Recognition Module

This aspect of the invention would permit users to generate reports and/or affidavits of service via voice recognition technology. Again, this feature could be used in connection with any aspect of the above described invention. The voice recognition technology would permit users to dictate in real time and thereafter have the transcribed report/affidavit uploaded into a central database for later retrieval. Form paragraph, headers, titles and other text may be automatically appended to the report/affidavit before it is uploaded.

Module for Embedding Photos into Reports

An additional feature can be included to permit the private investigator and/or process server to embed photos into reports or affidavits of service. In the case of a private investigators, photos taken during, for example, a stake out could be embedded into a report and uploaded into the database for later retrieval. Likewise, a process server could take a photo of the individual immediately after service as further evidence of effective service of process. Again, this photo could be uploaded separately into the database to be merged later with a report, or the photo could be automatically incorporated into a report and uploaded. Some additional features of this aspect of the invention include:
Upload the photo to a job in the software program.
Delivering the photo into a specific location inside the job profile.
Embedding the photo into a specific location on a form, like a P.I. Report, Process Server Affidavit and/or Proof of Service.
Embedding global position system (“GPS”) coordinates associated with the photos into a specific location on the forms. Google Maps® or other searched engine based maps can likewise be embedded into the reports.
Embed an image (as opposed to a photograph) onto a form.

In a further aspect of the invention, the system can be used to keep track of and tally expenses associated with a process server or private investigator. For example, hourly rates and other miscellaneous fees can be entered into the database. The program would automatically calculate the sub-totals for each category and the total expenses for the day. It then totals all the daily expenses for the job and calculates the grand total of expenses and fees for the job. The totaled amounts can be automatically placed into a specific location on the report or other form.

### Calendaring Module

The calendaring module allows dates associated with court related documents to be automatically calendared. Dates associated with the court related documents are entered into the system and exported to a calendar that is then accessible by the LSP. These dates may be, for example, the answer date for a complaint or the response date for a subpoena. E-mail reminders can be automatically sent via the system to any of the email addresses on file in the PSC system. The electronic calendar would allow the LSPs to keep track of other dates, such as dates related to vacation time, sick days, or work schedules. Other individuals who may want to be informed of the calendared dates may also be sent reminders as well.

### Example of PSC System

State Attorney's Offices, Public Defenders or other criminal justice agencies often issue subpoenas to law enforcement officers. These subpoenas may be created, printed, signed. The subpoena is then delivered to a process server, carrier, or an employee or subcontractor of a state, county of local agency, who, in turn, hand-delivers the subpoena to the law enforcement agency. The subpoena may be manually logged in by the law enforcement agency. The subpoena may then be delivered to the law enforcement officer. That officer may then review the subpoena and may sign a log book indicating receipt of the subpoena. The law enforcement officer must then coordinate with his supervisor regarding the subpoena and well as associated dates, such as court dates or dates for the production of evidence. As noted below, this entire process could be automated via the present PSC system.

In accordance with the invention, the State Attorney, or any LSP issuing the subpoena, creates it within the PSC system. The subpoena may also be manually generated outside of the PSC system and later uploaded into the PSC system. In either event, once the subpoena is created, a job record is created in the PSC system. The LSP issuing the subpoena then selects the law enforcement agency or other governmental agency that the subpoena is going to be delivered/served to. This may be accomplished via a drop down menu. The subpoena is then uploaded to a central database along with the relevant details from the job record. Additional attachments, such as photos or maps, may be appended to the subpoena and similarly uploaded to the database. The job record and attached subpoena/documents/files are electronically transferred to the intended recipient through the PSC system. If desired, the job record and attached subpoena/documents/files could also go directly to a recipient's e-mail address, either as a link or as an attachment.

Once the job record and attached subpoena/documents/files are electronically transmitted, the issuing entity (who will have to be a user of PSC) will get an electronic notification in their account or separate e-mail address, that the documents were delivered/served. The system can also be configured such that the individual law enforcement officer referenced in the subpoena will get an email or text alert on his smartphone or other mobile electronic device (i.e. any internet connected device configured to receive email or text messages). The alert will advise the law enforcement officer that he/she has been served with a legal document. The alert may also include the job record and attached subpoena/documents/files as a link or an attachment. A concurrent alert or message can optionally be sent to the supervisor(s) of record for the law enforcement officer. There would be an electronic record from beginning to end charting when the legal documents were generated, who received them, and associated dates and times.

The calendaring module would likewise automatically calendar any dates associated with the subpoena. These dates could be manually entered as part of the job record or they can be automatically generated based upon the date the subpoena was delivered. The calendar would automatically inform the law enforcement officer and/or his supervisor of the upcoming dates and provide necessary reminders. The email notifications could be sent to any email addresses associated with the particular job record. The calendar could also be used to track the work schedules, holiday, vacation, and/or sick days for the law enforcement officer and/or his supervisor.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A method for the automated delivery of legal documents, the method employing a computer network, a central database, the method being employed by issuing and receiving entities and comprising the following steps:
the issuing entity inputting data regarding a specific job, the data including the identity of the receiving entity;
the issuing entity uploading a legal document into the central database, the uploaded legal document being associated with the specific job;
the receiving entity downloading the legal document from the central database.

2. The method as described in claim 1 further comprising the step of the receiving entity printing out the downloaded legal document and delivering it to a third party.

3. The method as described in claim 1 further wherein the issuing entity provides dates associated with the specific job and the dates are recorded on a calendar that is accessible by the receiving party.

4. The method as described in claim 1 wherein the legal document is a subpoena.

5. A method for the automated delivery of legal documents, the method employing a computer network, a central database, the method being employed by issuing and receiving entities and comprising the following steps:
the issuing entity inputting data regarding a specific job;
the issuing entity uploading a legal document into the central database;
a notification being sent to the receiving entity once the legal document has been uploaded to the central database.

6. The method as described in claim 5 comprising the further step of the receiving entity retrieving the legal document from the central database following the notification.

7. The method as described in claim 1 wherein the issuing entity receives notification that the legal document has been delivered or served.

8. The method as described in claim 1 wherein a notification is sent to the receiving entity once the legal document has been uploaded to the central database.

9. The method as described in claim 7 wherein the notification is delivered via email.

10. The method as described in claim 7 wherein the notification is delivered via text message.

11. The method as described in claim 8 wherein the notification is delivered via email.

12. The method as described in claim 8 wherein the notification is delivered via text message.

13. The method as described in claim 7 wherein the notification is delivered via the computer network.

14. The method as described in claim 8 wherein the notification is delivered via the computer network.

15. The method as described in claim 7 wherein the legal document is delivered along with the notification.

16. The method as described in claim 8 wherein the legal document is delivered along with the notification.
